(19) United States
(12) Patent Application Publication
(10) Pub. No.: US 2022/0134268 A1
(43) Pub. Date: May 5, 2022

(54) MODULAR FILTER ELEMENT AND COUPLING

(71) Applicant: MADISON FILTER 981 LIMITED, Staffordshire (GB)

(72) Inventors: Detlef Hega, Bad Gandersheim (DE); Purv Purohit, Berlin (DE); Ian Colin Chisem, Warrington (GB)

(73) Assignee: MADISON FILTER 981 LIMITED, Staffordshire (GB)

(21) Appl. No.: 17/415,617

(22) PCT Filed: Dec. 10, 2019
(86) PCT No.: PCT/GB2019/053488

§ 371 Date: Jun. 17, 2021

(30) Foreign Application Priority Data
Dec. 18, 2018 (GB) 1820636.7

(51) Int. Cl. B01D 46/00; B01D 46/24

(52) U.S. Cl. CPC B01D 46/0005; B01D 46/2407; B01D 2265/04; B01D 2265/028; B01D 2273/20; B01D 46/0013

(57) ABSTRACT

The invention relates to a ceramic modular filter element comprising a first elongate hollow body, a second elongate body and a sleeve for coupling the first elongate body to the second elongate body, wherein the first elongate hollow body comprises a frustoconical section, the second elongate hollow body is configured to receive the frustoconical section of the first elongate hollow body and the sleeve comprises projections for engaging with a surface of the first elongate hollow body and/or the second elongate hollow body.

### TECHNICAL FIELD OF THE INVENTION

The present invention relates to a modular filter element and to the use of said modular filter element in a filtration plant.

### BACKGROUND TO THE INVENTION

Hot gas filtration is a process by which particulate matter is filtered from gas streams that typically have a temperature between 200° C. and 900° C. Ceramic filter elements are often used instead of traditional textile filter elements to remove particulates from hot gas streams since they exhibit superior filtration characteristics and do not substantially degrade at higher temperatures. Most commercially available single piece ceramic filter elements are available in lengths of up to 4.5 metres. However, it becomes increasingly difficult to manufacture, store, transport, handle and to fit the filter elements to filter housings when the length of the filter element exceeds 3 metres, and in applications where thousands of filter elements may be needed, the filter plant footprint and its cost also becomes prohibitive.

Modular filter elements formed from multiple filter element sub-sections are known in the art and were developed to overcome or at least alleviate some of the above-mentioned problems. One known modular filter element utilises a screw connection to join adjacent filter element sub-sections together. However, such filter elements suffer from the disadvantage that they are expensive to manufacture due to the machining involved in forming the screw threads, e.g., it is particularly difficult to machine the screw threads without forming cracks during the machining operation. Moreover, due to the nature of the connection, such modular filter elements suffer from sealing issues which can lead to a reduction in filtration performance. Filter elements are also known to vibrate in use and therefore there is a risk of the filter element sub-sections becoming partly or fully unscrewed. It will be appreciated that if filter element sub-sections become partly unscrewed then filtration performance will decline due to the absence of a gas tight seal. However, in more severe cases where the filter element sub-sections become fully unscrewed, the filter element sub-section below the joint may fall into a collection hopper thereby contaminating any filtered particulate matter in the hopper. Contamination of the particulate matter is undesirable, especially when the filtered particulate matter is valuable, and may result in it having to be discarded and/or the filtering operation being halted while the filter element sub-section is removed from the hopper.

In light of the above it is an object of embodiments of the invention to provide modular filter element that overcomes or ameliorates the problems associated with known modular filter elements. In particular, it is an object of embodiments of the present invention to provide a modular filter element that exhibits improved sealing performance. It is also an object of embodiments of the present invention to provide a modular filter element that exhibits a more robust connection between adjacent filter element sub-sections. It is a further object of objects of the present invention to provide a modular filter element that is less expensive and time consuming to manufacture.

### SUMMARY OF THE INVENTION

According to an aspect of the invention there is provided a ceramic modular filter element comprising a first elongate hollow body, a second elongate body and a sleeve for coupling the first elongate body to the second elongate body, wherein the first elongate hollow body comprises a frustoconical section, the second elongate hollow body is configured to receive the frustoconical section of the first elongate hollow body and the sleeve comprises projections for engaging with a surface of the first elongate hollow body and/or the second elongate hollow body.

The projections may comprise spikes, barbs, hooks, pyramids or a combination thereof. It will be appreciated that the projections can be provided on an outer surface of the sleeve, on an inner surface of the sleeve or on both the outer surface and the inner surface of the sleeve.

The projections may be arranged on a surface of the sleeve in a pre-determined pattern. For example, the projections may be spaced circumferentially around the sleeve in one or more rows.

The first elongate hollow body may comprise a contact section downstream of the frustoconical section. The contact section may be cylindrical. The diameter of the contact section may be greater than the diameter of the frustoconical section.

The filter element may comprise an annular body having axial webs extending therefrom. One or more of the axial webs may comprise an aperture. The aperture may be provided in an end region of the axial web distal from the annular body. The one or more apertures may be adapted to receive corresponding sleeve projections. In use, the apertures may overlie the contact section of the first elongate hollow body.

The sleeve may be arranged to overlie at least a portion of the axial webs so that in use the projections extend through the apertures into the first elongate hollow body. In particular, the sleeve and axial webs may be positioned so that the projections extend through the apertures into the contact section of the first elongate hollow body.

The annular body may be adapted to receive an adjustable clamping band. In particular, the annular body may comprise a circumferential groove to enable the adjustable clamping band to be retained in position. The clamping band may be formed from a metal or metal alloy such as steel, aluminium or the like. In alternative embodiments, the band may be formed from a suitable plastic material. The means for adjusting the size of clamping band may take any suitable form, but in one preferred embodiment, the adjustment means comprises a worm screw operable to engage with grooves or slots on the band.

In some embodiments the diameter of the sleeve may adjustable. For example, the sleeve may be an adjustable clamping band comprising projections on an inner and/or outer surface thereof. The sleeve may comprise means for adjusting the sleeve diameter. Any suitable means can be used to adjust the diameter of the sleeve but in one embodiment the adjustment means comprises a worm screw.

It will be appreciated that the modular filter element may comprise two or more sleeves.

The adjacent sleeves may be configured to form an interlocking connection, i.e. to form a modular sleeve. In a preferred embodiment, one sleeve may comprise a series of circumferentially spaced female members that are configured to receive corresponding circumferentially spaced males members provided on the adjacent sleeve. In particular, the female members may comprise slots and the male members may comprise hooks. The slots may be substantially L-shaped or J-shaped.

In some embodiments each sleeve may be adapted to receive an adjustable clamping band. For instance, the sleeve may comprise a circumferential channel to enable respective clamping bands to be held in position.

The sleeve may be adapted to fit around the frustoconical section of the first elongate hollow body. In particular, the sleeve may be conical or substantially conical in shape.

In some embodiments the sleeve may be perforated.

The sleeve may comprise a longitudinal gap that extends from one end of the sleeve to the other. The gap may be angled with respect to the horizontal and allows the sleeve to be opened and placed over the frustoconical section of an elongate hollow body.

The outer surface of the sleeve may comprise a radial ridge or a plurality of radial ridge sections that extend circumferentially around the sleeve. In one embodiment the radial ridge or radial ridge sections are arranged to extend helically around the sleeve.

An adhesive material may be provided at an interface between the elongate hollow bodies. In particular, adhesive material may be provided on an outer surface of the frustoconical section and/or on an inner surface of the second elongate hollow body adapted to receive the frustoconical section. The adhesive may be a ceramic cement adhesive, e.g. when the filter element is formed from a ceramic material.

The sleeve may be formed from a metal such as steel. In particular, the sleeve may be formed from stainless steel or coated mild steel. Sleeves formed from stainless steel are particularly advantageous since they exhibit good corrosion resistance to high temperature gas contaminants that may chemically corrode the support structure. The annular body and axial webs may be formed from the same material as the sleeve.

The conical angle of the frustoconical section may be between 75° and 89°, preferably between 80° and 89° and most preferably between 85° and 89°.

The length of the frustoconical section may be 100 mm to 200 mm and preferably 100 mm to 150 mm.

The filter element may comprise a catalyst. The catalyst may be any catalyst that is capable of removing gaseous contaminants from a gas stream. In particular, the catalyst may enable acid gases, NOx and dioxins to be simultaneously removed from a gas stream by selective catalytic reduction.

Each elongate hollow body may be open at one end. In particular, an upper end of each elongate hollow body may be open.

The open end of one elongate hollow body may comprise a flange for securing the filter element to a filter housing of a filtration apparatus. Accordingly, the elongate hollow body comprising the flange will normally be the uppermost elongate hollow body of the filter element, in which case the lower end of this elongate hollow body may be configured to engage with an upper end of an adjacent elongate hollow body. Given that the filter element is formed from a ceramic material, the flange may be integral with the first elongate hollow body and formed from a ceramics material. The ceramic flange may be provided with a metal plate for strengthening and protecting the ceramic flange during use. The metal plate may cover all or part of an outer surface of the ceramic flange.

The filter element may comprise one elongate hollow body having a closed end. The elongate hollow body may formed with a closed end or it may be formed with an open end and closed using an end cap. In use the elongate hollow body comprising the closed end will normally be the lowermost elongate hollow body in the filter element.

The length of the filter element may be greater than 3 metres. In particular, the filter element may have a length between 3 and 12 metres. In some embodiments the length of the first and second elongate hollow bodies is substantially the same. For example, the length of the first and second elongate hollow bodies may be greater than 1.5 metres, greater than 2 metres, greater than 2.5 metres, greater than 3 metres, greater than 3.5 metres, greater than 4 metres, greater than 4.5 metres, greater than 5 metres or greater than 5.5 metres.

In one embodiment of the invention, the filter element is a two-piece filter element comprising the first and second elongate hollow bodies

In some embodiments, one or more intermediate elongate hollow bodies may be provided between the first elongate hollow body and second elongate hollow body to increase the length of the modular filter element. For example, the filter element may be a three-piece filter element or a four-piece filter element The intermediate elongate hollow bodies may be open at their respective ends and joined together using the Similarly, the sleeve can be used to join an intermediate elongate body to the first elongate hollow body and/or to the second elongate hollow body. The upper and lower ends of the intermediate hollow bodies may be flangeless. In other embodiments filter element comprises three or more elongate hollow bodies. In particular, the filter element may be a three-piece filter element or a four-piece filter element.

According to a second aspect of the invention there is provided a method of producing a modular filter element according to the first aspect of the invention, the method comprising the steps of placing the sleeve over the frustoconical section or a contact section of the first elongate hollow body and then inserting the frustoconical section of the first elongate hollow body into the end of the second elongate hollow body adapted to receive said frustoconical section.

Since the method according to the second aspect of the invention is for producing the modular filter element according to the first aspect of the invention, it will be appreciated that the method according to the second aspect of the invention may incorporate any or all of the features described in relation to the modular filter element of the first aspect of the invention

The method may comprise the step of sliding the sleeve to a pre-determined position on first elongate body. In particular the sleeve may be slidably positioned to overlie at least a part of the frustoconical section or at least a part of the contact section.

The method may comprise the steps of applying an adhesive material on the frustoconical section and/or on an inner surface of the second elongate hollow body. Preferably the adhesive material is a concrete based adhesive.

According to a third aspect of the invention there is provided a coupling for a modular filter element, wherein the coupling comprises the sleeve according to the first aspect of the invention. In particular, the coupling may be used to couple the first and second elongate hollow bodies of the modular filter element according to the first aspect of the invention together. Accordingly, the coupling of the third aspect of the invention may incorporate any or all of the features described in relation to modular filter element of the first aspect of the invention. For instance, the coupling may include the sleeve and the annular body with axial webs. Alternatively, the coupling may include two or more sleeves. The sleeves may be configured to form an interlocking connection such as a bayonet connection for example.

According to a fourth aspect of the invention there is provided the use of a modular filter element according to the first aspect of the invention in a filter plant for filtering particulate matter from hot gas streams.

### DETAILED DESCRIPTION OF THE INVENTION

In order that the invention may be more clearly understood one or more embodiments thereof will now be described, by way of example only, with reference to the accompanying drawings, of which:

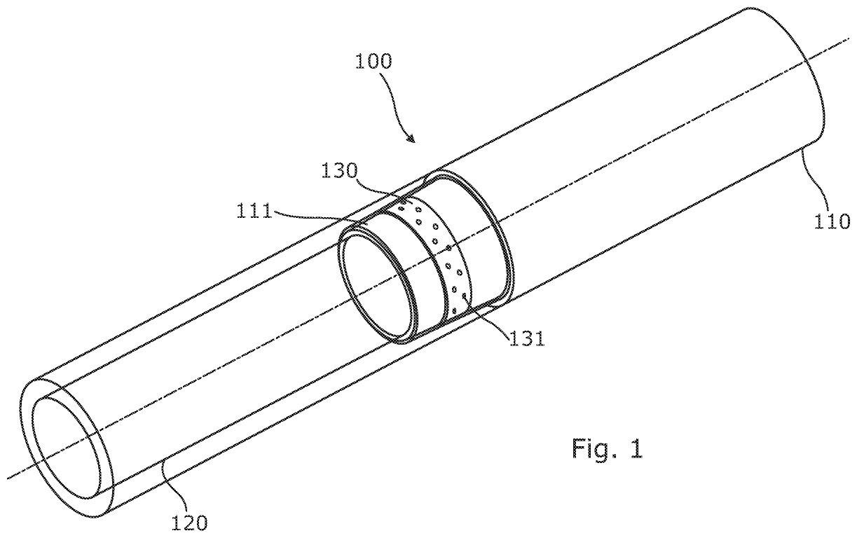

FIG. 1 shows a perspective view of a modular filter element according to one embodiment of the invention.

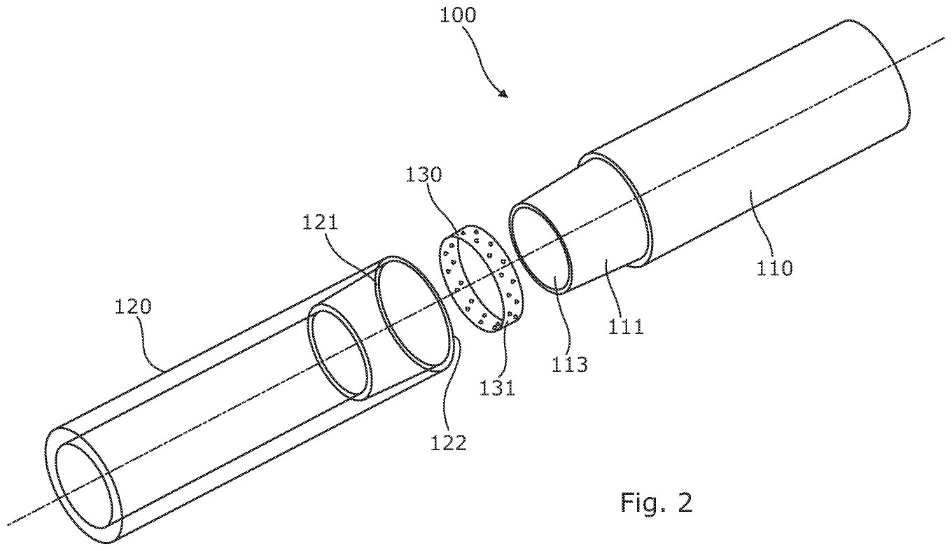

FIG. 2 shows an exploded view of the modular filter element shown in FIG. 1.

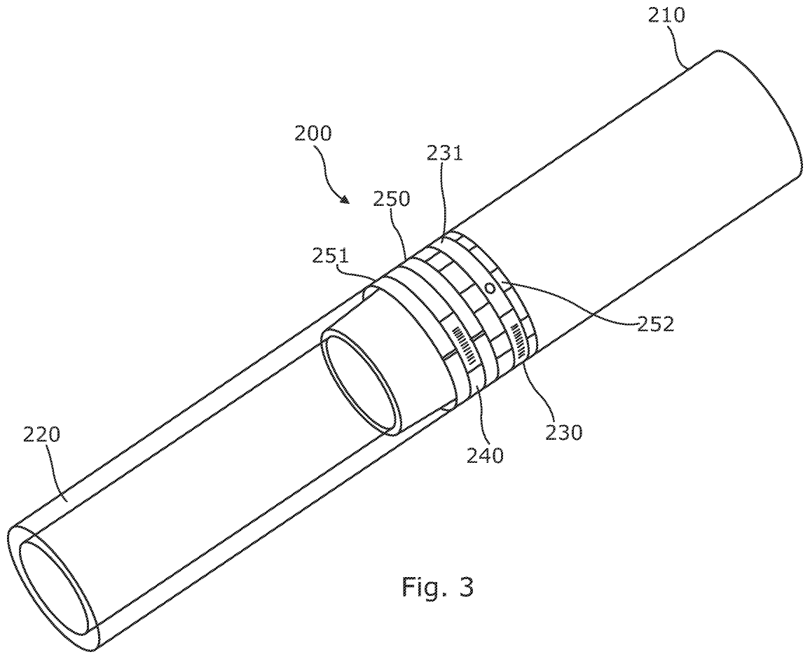

FIG. 3 shows a perspective view of a modular filter element according to a second embodiment of the invention

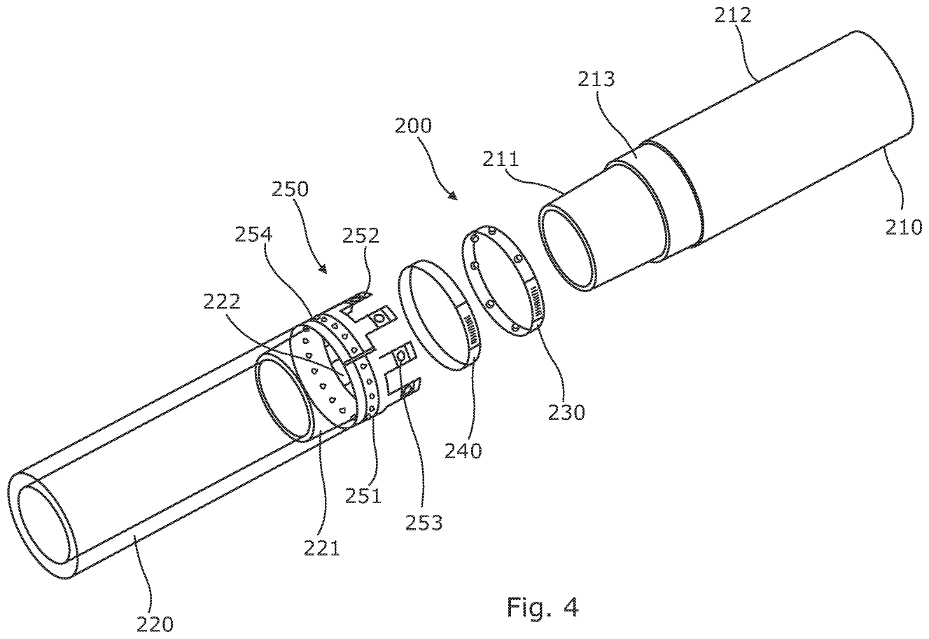

FIG. 4 shows an exploded view of the modular filter element shown in FIG. 3.

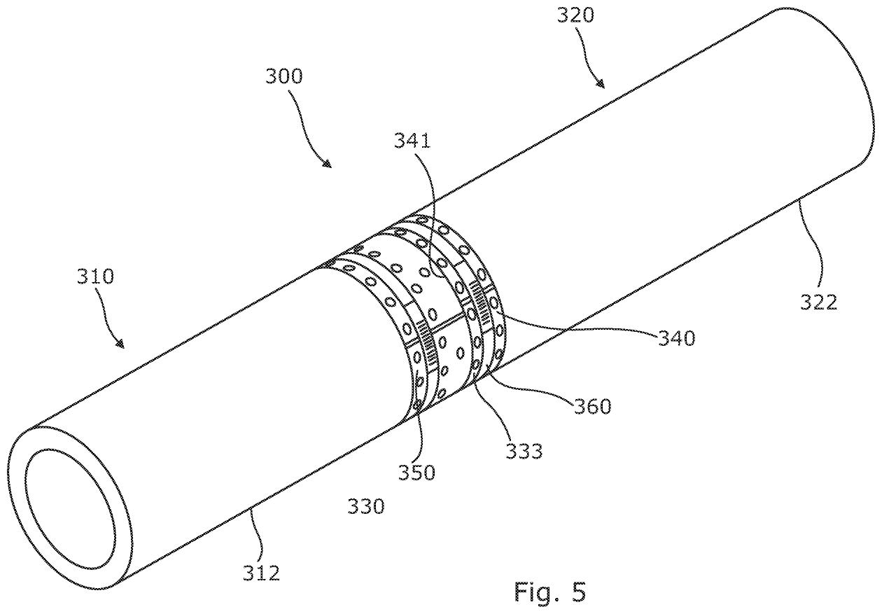

FIG. 5 shows a perspective view of a modular filter element according to a second embodiment of the invention.

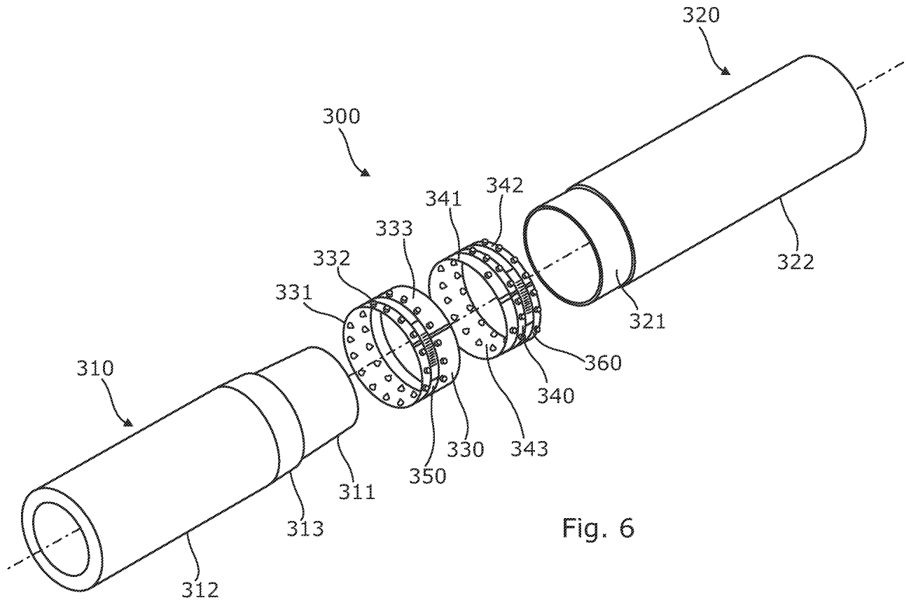

FIG. 6 shows an exploded view of the modular filter element shown in FIG. 5

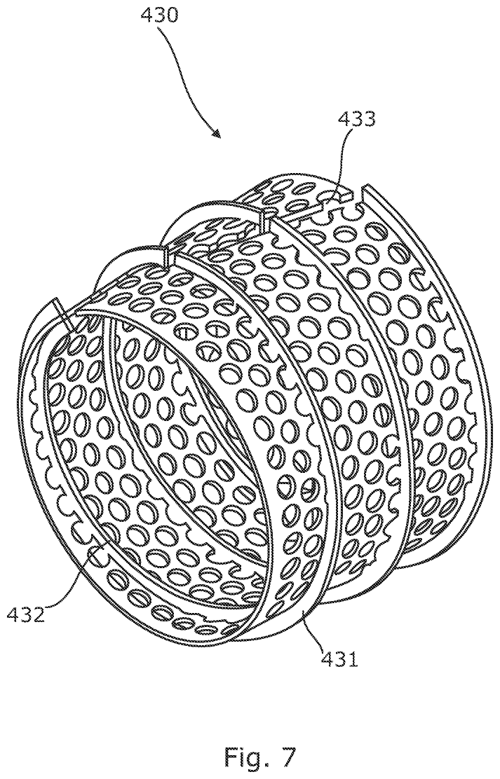

FIG. 7 shows a perspective view of a sleeve according to a fourth embodiment of the invention.

Turning now to FIGS. 1 and 2, the modular filter element according to a first embodiment of the invention comprises a first elongate hollow body 110, a second elongate hollow body 120 and a sleeve in the form of a ring 130. The first elongate hollow body 110 comprises a frustoconical section 111 and a tubular section 112 downstream of the frustoconical section 111. The diameter of the tubular section 112 is substantially constant along its length and is greater than the diameter of the frustoconical section 111. As best shown in FIG. 1, the walls of the frustoconical section 111 taper inwardly from the tubular section 112 towards the mouth 113 of the frustoconical section 111. In this embodiment the frustoconical section 111 is 110 mm in length and the walls taper inwardly at an angle of 87°. The second elongate hollow body 120 is adapted to receive the frustoconical section 111 of the first elongate hollow body 110. In this connection the internal walls 121 of the second elongate hollow body 20 taper inwardly at an angle of 87° from its mouth 122 towards a region of the second elongate hollow body 120 distal from the mouth 122. The sleeve 130 in this embodiment is provided with projections 131 in the form of spikes or barbs. The spikes or barbs 31 are adapted to engage with an inner surface of the second elongate hollow body 120 and an outer surface of the frustoconical section 111. Accordingly, the spikes or barbs 131 are provided on both an inner surface of the sleeve 130 and an outer surface of the sleeve 130. The modular filter element 100 additionally comprises a cement based adhesive (not shown). The cement based adhesive reinforces the connection between the frustoconical section 111 and the end of the second elongate hollow body 20 adapted to receive the frustoconical section 111. It also reinforces the connection between the sleeve 130 and the frustoconical section 111. In some embodiments of the invention the modular filter element comprises two spiked or barbed sleeves 130 adapted to fit around the frustoconical section 111. Accordingly, the sleeves will have different diameters so that they can overlie different regions of the frustoconical section 111.

To assemble the modular filter element 100, the cement based adhesive is first applied over the frustoconical section 111 of the first elongate body 110. Then, and before the cement based adhesive has solidified, the sleeve 130 is slidably moved over the frustoconical section 111 until the spikes or barbs 131 located on the inner surface of the sleeve 130 frictionally engage with the outer surface of the frustoconical section 111 and the cement based adhesive provided thereon. As best shown in FIG. 1, the sleeve 130 is adapted so that it can only slide along part of the frustoconical section 130 meaning that frictional engagement of the barbs or spikes 131 occurs in a substantially central region of the frustoconical section 111. The frustoconical section 111 and sleeve 130 are then inserted into the second elongate hollow body 120 causing the spikes or barbs 131 located on the outer sleeve 130 surface to frictionally engage with the inner surface of the second elongate hollow body 120. The cement based adhesive is then left to harden in order to strengthen the connection between the first and second elongate hollow bodies 110, 120 and to provide a gas tight seal.

FIGS. 3 and 4 show a modular filter element 200 in accordance with a second embodiment of the invention. The modular filter element 200 comprises a first elongate hollow body 210, a second elongate hollow body 220 and a sleeve 230. The first elongate hollow body comprises a frustoconical section 211, a contact section 213 downstream of the frustoconical section 211 and a tubular section 212 downstream of the contact section 213. The frustoconical section 211 is 110 mm in length and has an angle of conicity of 87°. As best shown in FIG. 4, the diameter of the contact section 213 is greater than the diameter of the frustoconical section 211 and the diameter of the tubular section 212 is greater than the diameter of the contact section 213. The second elongate hollow body 220 is adapted to receive the frustoconical section 211, but not the contact section 213, of the first elongate hollow body 210. In this connection the internal walls 221 of the second elongate hollow body 220 taper inwardly at an angle of 87° from its mouth 222 towards a region of the second elongate hollow body distal from the mouth 222.

The inner surface of the sleeve 230 is provided with eight circumferential spaced spikes 231 that are adapted to engage with the contact section 213 of the first elongate hollow body 210. The diameter of the sleeve 230 is adjustable meaning that it can be positioned over the contact section 213 of the first elongate hollow body 210 and then tightened in order to retain the sleeve 230 on the contact section 213. The sleeve 213 in this embodiment is a form of an adjustable clamping band such as a hose clip. As best shown in FIG. 4, the modular filter element 200 additionally comprises a clamping band 240 (without spikes) and a crown member 250 that is adapted to cooperate with the spiked sleeve 230 to enable the first and second elongate hollow bodies 210, 220 to be joined together. The crown member 250 comprises an annular body 251 and a series of circumferentially spaced apart webs 252 that extend axially from the annular body 251. Each web 252 is provided with an aperture 253 that is adapted to receive a spike 231 from the sleeve 230. The exterior surface of the annular body 251 comprises a circumferential groove 254 for receiving the adjustable clamping band 240. The circumferential groove 254 is adapted to a have a width corresponding to the clamping band 240 so that when the clamping band 240 is tightened it is retained within the groove 254.

The modular filter element also comprises a cement based adhesive (not shown) for reinforcing the connection between the first and second elongate hollow bodies. In particular, the exterior surface of the frustoconical section 211 is coated with the cement based adhesive so that an adhesive bond can form between the frustoconical section 211 and the internal walls 221 of the second elongate body 220.

To produce the modular filter element 200 according to the second embodiment of the invention the annular body 251 of the crown member 250 is arranged over the end of the second elongate hollow body 220 adapted to receive the frustoconical section 211 of the first elongate body 210. In particular, the crown member 250 is arranged so that the axial webs 252 extend away from the second elongate hollow body 220 in the direction of the first elongate hollow body 210 (FIG. 4). The adjustable clamping band 240 is then passed over the axial webs 252 until it overlies the circumferential groove 254 formed in the annular body 211. The adjustable clamping band 240 is then tightened using a worm screw arrangement which engages with grooves or slots formed in the adjustable clamping band 240. Once the crown member 250 has been secured to the second elongate hollow body 220, the frustoconical section 211 is fed through the spiked sleeve 230 and then into the mouth 222 of the second elongate hollow body 220 which adapted to receive the frustoconical section 211. As the frustoconical section 211 is inserted, the axial webs 252 pass through the spiked sleeve 230 until the respective ends of the axial webs 252 abut a wall of the tubular section 212. This locates the apertures 253 formed in the axial webs 252 over the contact section 251 of the first elongate hollow body 210. The spiked sleeve 230 is then positioned so that the spikes 231 align with the apertures 253 in the axial webs 252, and once aligned, the spiked sleeve 230 is tightened using a worm screw arrangement which engages with grooves or slots formed on the outer surface of the sleeve 230. As the sleeve 230 is tightened and brought into contact with the axial webs 252, the spikes 231 extend through the apertures into the contact section 213 of the first elongate body 210 to connect the first elongate hollow body 210 to the second elongate hollow body 220. The connection between the first and second elongate hollow bodies 210, 220 is further reinforced by the provision of the concrete based adhesive which is applied to the outer surface of the frustoconical section 211 prior to the step of inserting the frustoconical section 211 into the mouth 222 of the second elongate hollow body 220. In addition to reinforcing the connection between the first and second elongate bodies 210, 220 the concrete based adhesive forms a gas tight seal once it has solidified.

Turning now to FIG. 5 and FIG. 6, the modular filter element 300 according to a third embodiment of the invention comprises a first elongate hollow body 310, a second elongate hollow body 320 and two sleeves 330 and 340.

The first elongate hollow body 310 comprises a frustoconical section 311, a contact section 313 downstream of the frustoconical section 311 and a tubular section 312 downstream of the contact section 313. The frustoconical section 311 is 110 mm in length and has an angle of conicity of 87°. The diameter of the contact section 313 is greater than the diameter of the frustoconical section 311 and the diameter of the tubular section 312 is greater than the diameter of the contact section 313. The second elongate hollow body 320 is adapted to receive the frustoconical section 311 and comprises a contact section 321 and a tubular section 322 downstream of the contact section 321. The diameter of the tubular section 322 is greater than the diameter of the contact section 321.

As best shown in FIG. 6, the exterior surface of the first sleeve 330 is provided with a first circumferential channel 332 that is adapted to have a width corresponding to a first clamping band 350. FIG. 6 also shows that the first sleeve 330 comprises two rows of circumferentially spaced spikes 331 provided on the inner surface of the first sleeve 330 for engaging the outer surface of the contact section 313 of the first elongate hollow body 310. The first sleeve 330 additionally comprises a series of circumferentially spaced slots 333 that are adapted to receive corresponding hook members located 341 on the second sleeve 340. As best shown in FIG. 6, the slots 333 comprise an axial region which extends upwards from the rim towards the first circumferential channel 332 and a region that is angled with respect to the axial region.

The second sleeve 340 comprises a second circumferential channel 342 that is adapted to have a width corresponding to a second adjustable clamping band 360. The second adjustable clamping band 360 comprises a worm screw arrangement which engages with grooves or slots formed in the adjustable clamping band 360. The second sleeve 340 comprises two rows of circumferentially spaced spikes 343 provided on the interior surface of the second sleeve 340 for engagement with the exterior surface of the contact section 321 of the second elongate hollow body 320. As shown in FIGS. 5 and 6, the hook members 341 are provided at the rim of the second sleeve 340 to permit interengagement with the slots 333 formed in the first sleeve 330. In this embodiment a cement based adhesive is provided on an outer surface of the frustoconical section 311 and on an inner surface of the contact section 321 of the second elongate hollow body 320.

To produce the modular filter element 300 in accordance with the third embodiment of the invention, a layer of cement based adhesive is first provided on the outer surface of the frustoconical section 311 and on the inner surface of the contact section 321 of the second elongate hollow body 320. The first sleeve 330 is then arranged over first elongate hollow body 310 so that the spikes 331 overlie the contact section 313 of the first elongate hollow body 310 and the slots 333 face the second elongate hollow body 320. The first sleeve 330 is subsequently secured to the contact section 313 of the first elongate hollow body 310 by tightening the adjustable clamping band 350 using the worm screw arrangement. This in turn causes the spikes 331 to contact and subsequently penetrate the concrete adhesive layer and the outer surface of the contact section 313 of the first elongate hollow body 310. A similar procedure is then undertaken to secure the second sleeve 340 to the second elongate hollow body 320. Specifically, the second sleeve 340 is arranged so that, in use, the hook members 341 face the first elongate hollow body 310 and the spikes 343 face the contact section 321 of the second elongate hollow body 320. The adjustable clamping band 360 is then tightened using the worm screw arrangement which causes the spikes 343 to penetrate the outer surface of the contact section 321 of the second elongate hollow body 320. Once the respective sleeves 330, 340 have been secured to the first and second elongate hollow bodies 310, 320, the frustoconical section 311 is inserted into the mouth of the second elongate hollow body 320 which is adapted to receive the frustoconical section 311. At the same time, and if necessary, the first and/or second elongate hollow bodies 310, 320 may be rotated to align the hook members 341 with the slots 333, so that as the frustoconical section 311 is inserted into the second elongate hollow body 320, the hook members 341 travel along the axial region of the slot 333. Then, as the hook members reach the angled region of the slot 333, the first and/or second elongate hollow bodies 310, 320 may be rotated further to enable the hook members 341 to travel along the angled slot region. With the hook members abutting the ends of the slots 333, concrete adhesive is applied in the axial region and in the angled region of the slots 333 behind the hook member 341 in order to retain the hook member 341 in the slot 333. This connection is further reinforced by the provision of the concrete based adhesive at the interface between the frustoconical section 311 and the inner surface of the contact section 321 of the second elongate hollow body 320.

FIG. 7 shows a sleeve 430 in accordance with present invention for connecting adjacent filter element sub-sections together. The sleeve 430 is perforated in order to minimise the restriction of air flow through the filter element. The sleeve 430 is also substantially cone-shaped and is adapted to fit over the frustoconical section of the first elongate body. As best shown in FIG. 7, the conical sleeve 430 comprises a plurality of exterior radial ridge sections 431 that extend circumferentially around the outer surface of the sleeve 430, and in this embodiment, the exterior radial ridge sections 431 are arranged to define a substantially helical structure that is adapted to cut into the inner wall of the second elongate hollow body. Similarly, a series of internal radial ridge sections 432 extend inwardly from an inner surface of the sleeve 430 and are arranged to define a substantially helical internal structure on the inner surface of the sleeve 430 that is adapted to cut into the outer surface of the frustoconical section over which the conical sleeve is placed. As best shown in FIG. 7, the sleeve 430 comprise a longitudinal gap 433 that extends from one end of the sleeve to the other. The gap 433 is angled with respect to the horizontal and allows the sleeve to be opened and placed over the frustoconical section of an elongate hollow body.

The above embodiments are described by way of example only. Many variations are possible without departing from the scope of the invention.

1. A ceramic modular filter element comprising a first elongate hollow body, a second elongate body and a sleeve for coupling the first elongate body to the second elongate body, wherein the first elongate hollow body comprises a frustoconical section, the second elongate hollow body is configured to receive the frustoconical section of the first elongate hollow body and the sleeve comprises projections for engaging with a surface of the first elongate hollow body and/or the second elongate hollow body.

2. A modular filter element according to claim 1, wherein the projections comprise spikes, barbs, hooks, pyramids or ridges.

3. A modular filter element according to claim 1, wherein the projections are provided on an outer surface of the sleeve and/or on an inner surface of the sleeve.

4. (canceled)

5. A modular filter element according to claim 1, wherein the projections are spaced circumferentially around the sleeve in one or more rows.

6. A modular filter element according to claim 1, wherein the filter element comprises an annular body having axial webs extending therefrom.

7. A modular filter element according to claim 6, wherein one or more axial webs comprise an aperture.

8. A modular filter element according to claim 7, wherein the sleeve is arranged to overlie at least a portion of the axial webs so that the projections extend through the apertures into the first elongate hollow body.

9. A modular filter element according to claim 8, wherein the projections extend through the apertures into a contact section located downstream of the frustoconical section.

10. A modular filter element according to claim 6, wherein the annular body is adapted to receive an adjustable clamping band.

11. A modular filter element according to claim 10, wherein the annular body comprises a circumferential groove to enable the adjustable clamping band to be retained in position.

12. A modular filter element according to claim 1, wherein the diameter of the sleeve is adjustable.

13. A modular filter element according to claim 1, wherein the filter element comprises two or more sleeves.

14. (canceled)

15. A modular filter element according to claim 12, wherein each sleeve comprises a circumferential channel to enable the respective clamping bands to be held in position.

16. A modular filter element according to claim 13, wherein adjacent sleeves are configured to form an interlocking connection.

17. A modular filter element according to claim 16, wherein one sleeve comprises a series of circumferentially spaced slots that are configured to receive corresponding circumferentially spaced hooks provided on the adjacent sleeve.

18. (canceled)

19. A modular filter element according to claim 1, wherein the sleeve is perforated.

20. A modular filter element according to claim 19, wherein an outer surface of the sleeve comprises a radial ridge or a plurality of radial ridge sections that extend circumferentially around the sleeve.

21. A modular filter element according to claim 20, wherein the radial ridge or radial ridge sections are arranged to extend helically around the sleeve.

22. A modular filter element according to claim 1, wherein the frustoconical section of the sleeve has a conical angle of between 75° and 89°.

23. (canceled)

24. (canceled)

25. Use of the filter element according to claim 1 in a filter plant for filtering particulate matter from hot gas streams.
